(19) United States
(12) Patent Application Publication
(10) Pub. No.: US 2025/0216933 A1
(43) Pub. Date: Jul. 3, 2025

(54) POSE PREDICTION METHOD, TERMINAL DEVICE, AND STORAGE MEDIUM

(71) Applicant: Beijing Zitiao Network Technology Co., Ltd., Beijing (CN)

(72) Inventor: Kai HUANG, Beijing (CN)

(21) Appl. No.: 18/991,313

(22) Filed: Dec. 20, 2024

(30) Foreign Application Priority Data
Dec. 27, 2023 (CN) 202311833982.8

(51) Int. Cl. G06F 3/01; G06F 17/16

(52) U.S. Cl. CPC G06F 3/012; G06F 17/16

(57) ABSTRACT

The present disclosure provides a pose prediction method and apparatus, a terminal device, and a storage medium, and the method includes: acquiring first motion information of a user during a first historical period and a current pose of the user; determining high-order information associated with motion of the user during the first historical period according to the first motion information; determining second motion information of the user during a future period according to the high-order information and the first motion information; and predicting a target pose of the user at a target moment according to the second motion information of the user during the future period and the current pose.

### CROSS-REFERENCE TO RELATED APPLICATION

The present application claims the priority to Chinese Patent Application No. 202311833982.8, filed on Dec. 27, 2023, the entire disclosure of which is incorporated herein by reference as portion of the present application.

### TECHNICAL FIELD

Embodiments of the present disclosure relate to a pose prediction method and apparatus, a terminal device, and a storage medium.

### BACKGROUND

In the field of extended reality technology, a terminal device can acquire a pose of a user's head, render a relevant image based on the pose, and display the image on a screen. Because there is a certain latency between image rendering and displaying the image on the screen, terminal devices can predict the pose of the user's head in advance to avoid mismatch between the pose and the image.

Currently, the terminal device can determine that the user's head moves at a constant velocity. Therefore, the terminal device can calculate the pose of the user's head at a future moment based on the current pose of the user's head, the initial linear velocity of the user's head, the initial angular velocity of the user's head, and the prediction duration. For example, using displacement distance as an example, the terminal device can determine the displacement distance of the user's head by multiplying the initial linear velocity with the prediction duration, thereby predicting the pose of the user's head at a future moment. However, when the user is moving more vigorously, the accuracy of the terminal device's prediction of the pose of the user's head is relatively poor.

### SUMMARY

The present disclosure provides a pose prediction method and apparatus, a terminal device, and a storage medium.

In a first aspect, the present disclosure provides a pose prediction method, which includes:
acquiring first motion information of a user during a first historical period and a current pose of the user;
determining high-order information associated with motion of the user during the first historical period according to the first motion information;
determining second motion information of the user during a future period according to the high-order information and the first motion information; and
predicting a target pose of the user at a target moment according to the second motion information of the user during the future period and the current pose.

In a second aspect, the present disclosure provides a pose prediction apparatus, which includes an acquisition module, a first determination module, a second determination module, and a prediction module;
the acquisition module is configured to acquire first motion information of a user during a first historical period and the current pose of the user;
the first determination module is configured to determine high-order information associated with motion of the user during the first historical period according to the first motion information;
the second determination module is configured to determine second motion information of the user during a future period according to the high-order information and the first motion information; and
the prediction module is configured to predict a target pose of the user at a target moment according to the second motion information of the user during the future period and the current pose.

In a third aspect, the present disclosure provides a terminal device, which includes a processor and a memory;
the memory is configured to store computer-executable instructions; and
the processor is configured to execute the computer-executable instructions stored in the memory to implement the pose prediction method according to the first aspect or any embodiment of the first aspect.

In a fourth aspect, the present disclosure provides a non-transitory computer-readable storage medium, which stores computer-executable instructions, and a processor, when executing the computer-executable instructions, implements the pose prediction method according to the first aspect or any embodiment of the first aspect.

### BRIEF DESCRIPTION OF DRAWINGS

In order to more clearly illustrate the technical solutions in the embodiments of the present disclosure, the drawings to be used in the description of the embodiments will be briefly described below. Obviously, the drawings in the following description are only some embodiments recorded in the present disclosure. For those ordinarily skilled in the art, other drawings may be obtained based on these drawings without inventive work.

FIG. 1 is a schematic diagram of an application scenario provided by the embodiments of the present disclosure;

FIG. 2 is a schematic flowchart of a pose prediction method provided by the embodiments of the present disclosure;

FIG. 3 is a schematic diagram of predicted motion information provided by the embodiments of the present disclosure;

FIG. 4 is a schematic diagram of a target linear velocity provided by the embodiments of the present disclosure;

FIG. 5 is a schematic diagram of a target displacement provided by the embodiments of the present disclosure;

FIG. 6 is a schematic diagram of a method for determining a linear velocity prediction duration provided by the embodiments of the present disclosure;

FIG. 7 is a schematic diagram of a method for determining an angular velocity prediction duration provided by the embodiments of the present disclosure;

FIG. 8 is a schematic structural diagram of a pose prediction apparatus provided by the embodiments of the present disclosure; and

FIG. 9 is a schematic structural diagram of a terminal device provided by the embodiments of the present disclosure.

### DETAILED DESCRIPTION

Exemplary embodiments will be described in detail here, and the exemplary embodiments are shown in the drawings. In the case where the following description refers to the drawings, same numbers in different drawings represent the same or similar elements unless otherwise indicated. The implementations described in the following exemplary embodiments do not represent all implementations consistent with the present disclosure. Rather, they are merely examples of apparatuses and methods consistent with some aspects of the present disclosure, as detailed in the appended claims.

For ease of understanding, concepts involved in the embodiments of the present disclosure are explained below.

A terminal device is a device having wireless receiving and sending functions. The terminal device may be deployed on land, e.g., in a room or outdoors, held in hand, worn, or on a vehicle. The terminal device may be a mobile phone, a Pad, a computer with wireless receiving and sending functions, a virtual reality (VR) terminal device, an augmented reality (AR) terminal device, a wireless terminal in industrial control, an vehicle-mounted terminal device, a wireless terminal in self driving, a wireless terminal device in remote medical, a wireless terminal device in smart grid, a wireless terminal device in transportation safety, a wireless terminal device in smart city, a wireless terminal device in smart home, a wearable terminal device, or the like. The terminal device involved in the embodiments of the present disclosure may also be referred to as a terminal, user equipment (UE), an access terminal device, a vehicle-mounted terminal, an industrial control terminal, a UE unit, a UE station, a mobile station, a mobile platform, a distant station, a remote terminal device, a mobile device, a UE terminal device, a wireless communication device, a UE agent, a UE apparatus, or the like. The terminal device may be stationary or mobile.

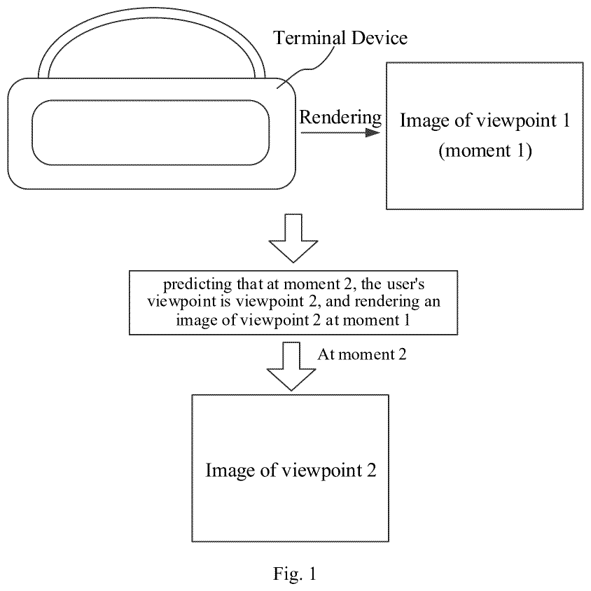

Next, with reference to FIG. 1, an application scenario of the embodiments of the present disclosure will be described.

FIG. 1 is a schematic diagram of an application scenario provided by the embodiments of the present disclosure. Please refer to FIG. 1 which includes a terminal device. At moment 1, the user's viewpoint is viewpoint 1, and the terminal device can render an image of viewpoint 1. The terminal device can predict that at moment 2, the user's viewpoint is viewpoint 2, and render an image of viewpoint 2 at moment 1. At moment 2, the terminal device can directly display the image of viewpoint 2. In this way, the terminal device can improve its display effect by predicting the viewpoint, eliminating the need to render the current image in real-time.

It should be noted that FIG. 1 is only an example of an application scenario of the embodiments of the present disclosure, and is not a limitation of the application scenarios of the embodiments of the present disclosure.

In the related art, terminal devices can acquire a pose of the user's head, determine the user's viewpoint according to the pose, render a relevant image, and display the image on a screen. Because there is a certain latency between image rendering and displaying the image on the screen, terminal devices can predict the pose of the user's head in advance to avoid mismatch between the pose and the image. Currently, the terminal device can determine that the user's head moves at a constant velocity. Therefore, the terminal device can calculate the pose of the user's head at a future moment based on the current pose of the user's head, the initial linear velocity of the user's head, the initial angular velocity of the user's head, and the prediction duration. For example, the terminal device can determine the displacement distance of the user's head by multiplying the initial linear velocity with the prediction duration, and determine the displacement angle (orientation) of the user's head by multiplying the initial angular velocity with the prediction duration, thereby predicting the pose of the user's head at a future moment according to the initial pose, displacement distance and orientation of the user's head. However, when the user is moving more vigorously, the accuracy of displacement and orientation calculated based on uniform motion is lower, which consequently leads to poorer accuracy in the predicted pose of the user's head by the terminal device.

To solve the technical problems of the related art, an embodiment of the present disclosure provides a pose prediction method. A terminal device may acquire first motion information of a user during a first historical period and a current pose of the user, acquire a first high-order coefficient matrix, determine an inverse matrix of the first high-order coefficient matrix, and determine the product of the inverse matrix of the first high-order coefficient matrix and the first motion information as high-order information; the terminal device may determine second motion information of the user during a future period according to the high-order information and the first motion information; and the terminal device may predict a target pose of the user at a target moment according to the second motion information of the user during the future period and the current pose. In the above-mentioned method, because the second motion information is determined by the terminal device based on the first motion information (historical motion information) and the higher-order information, the second motion information may include the higher-order information of motion of the user during the historical period, and because the higher-order information may accurately indicate non-uniform motion of the user, the terminal device may accurately predict the target pose of the user at the target moment based on the second motion information, thereby improving the accuracy of pose prediction.

The technical solutions of the present disclosure and how the technical solutions of the present disclosure can solve the above-mentioned technical problems will be described in detail with specific embodiments. The following specific embodiments may be combined with each other, and the same or similar concepts or processes may not be repeated in some embodiments. The embodiments of the present disclosure will be described below with reference to the drawings.

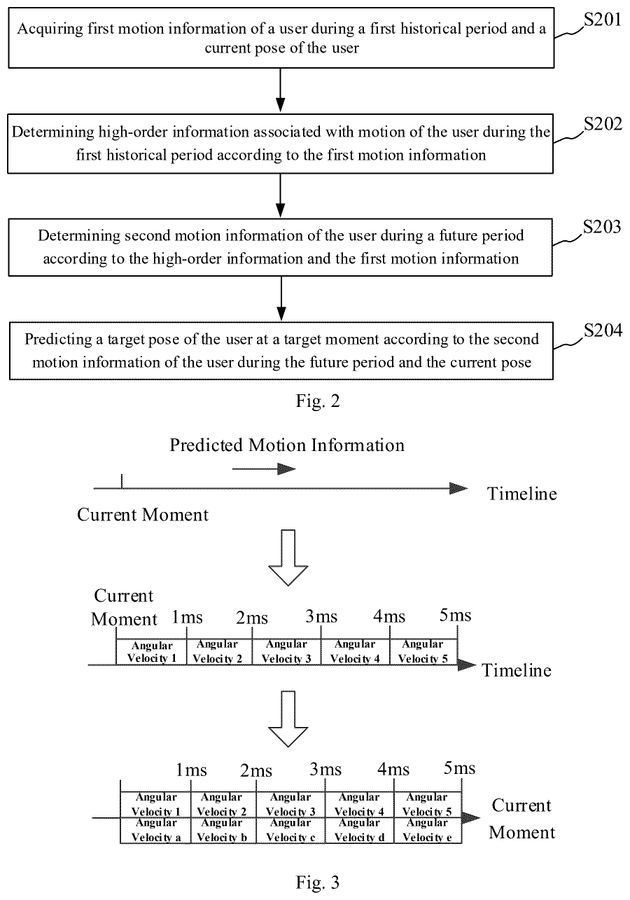

FIG. 2 is a schematic flowchart of a pose prediction method provided by the embodiments of the present disclosure. Referring to FIG. 2, the method may include the following steps.

In S201, acquiring first motion information of a user during a first historical period and a current pose of the user.

The execution subject of the embodiments of the present disclosure may be a terminal device or a pose prediction apparatus provided in the terminal device. Here, the pose prediction apparatus may be realized based on software, and the pose prediction apparatus may also be realized based on the combination of software and hardware, which is not limited by the embodiments of the present disclosure.

Here, the user may be a user utilizing the terminal device. For example, the terminal device may be a head-mounted input device, the user may wear the terminal device on the head, and the terminal device may determine the pose of the user's head based on data collected by sensors.

It should be noted that the terminal device may also be an input device worn on any part of the user's body (for example, an input device worn on the user's hand), which is not limited by the embodiments of the present disclosure.

For example, the first historical period may be any period such as 1 second, 10 seconds, 20 seconds and 30 seconds before the current moment, which is not limited by the embodiments of the present disclosure.

The first motion information may be motion information of the user during the first historical period. For example, the first motion information may be motion information of the terminal device during the first historical period. For example, the motion information may include angular velocities and linear velocities, and the first motion information may be information related to the angular velocities and information related to the linear velocities during the first historical period. For example, in response to the first historical period being 10 milliseconds, the first motion information may include 10 angular velocities and 10 linear in velocities, that is, the first motion information may include angular velocities and linear velocities for every millisecond during the first historical period.

It should be noted that because the terminal device may be worn on the user's head, the first motion information may be motion information of the user's head during the first historical period.

It should be noted that the first motion information may include any information related to the motion of the user during the first historical period, which is not limited by the embodiments of the present disclosure.

Alternatively, the terminal device may determine the first motion information according to data collected by one or more sensors. For example, the terminal device may include an inertial measurement unit (IMU), which is able to collect the angular velocity and the linear velocity of the terminal device in real time based on a preset sampling frequency, and then obtain the first motion information of the user during the first historical period. For example, the IMU may collect data every millisecond, so that the terminal device can obtain the linear velocity and angular velocity for each millisecond.

It should be noted that the terminal device may obtain the first motion information of the user during the first historical period by means of any feasible implementation mode, which is not limited by the embodiments of the present disclosure.

The current pose may be the pose of the user at the current moment, and the pose may include at least one of position and orientation. For example, the pose of the user may be the position of the user's head (or other parts of the user's body, depending on where the user is wearing the terminal device), the pose of the user may be the orientation of the user's head, and the pose of the user may also be the position of the user's head and the orientation of the user's head, which is not limited by the embodiments of the present disclosure. Here, the current pose of the user's head is only an example of the current pose of the embodiments of the present disclosure, and is not a limitation of the current pose of the embodiments of the present disclosure.

Alternatively, the terminal device may determine the current pose of the user according to the data collected by the sensor (for example, the terminal device may determine the pose of the user according to images collected by a camera, data collected by the IMU, data collected by a gyroscope, etc.), and the terminal device may also determine the current pose of the user by means of any feasible implementation mode, which is not limited by the embodiments of the present disclosure.

In S202, determining high-order information associated with motion of the user during the first historical period according to the first motion information.

Here, the high-order information may be high-order information associated with the motion of the user. For example, the high-order information may include second-order information, third-order information, fourth-order information, etc., which is not limited by the embodiments of the present disclosure. For example, taking linear velocity as an example, the product of velocity and time is first-order information (low-order information), and the product of linear acceleration and the square of time is second-order information (high-order information).

Alternatively, the terminal device may determine the high-order information associated with the motion of the user during the first historical period by means of the following feasible implementation mode: acquiring a first high-order coefficient matrix, determining an inverse matrix of the first high-order coefficient matrix, and determining the product of the inverse matrix of the first high-order coefficient matrix and the first motion information as the high-order information.

The first high-order coefficient matrix is used to acquire high-order motion information. For example, the first high-order coefficient matrix may be a preset high-order polynomial coefficient matrix. For example, the first higher-order coefficient matrix may be expressed by the following formula:

$$J = ( \begin{matrix}1 & {( - n + 1 )}^{1} & {( - n + 1 )}^{2} & {( - n + 1 )}^{3} & … & {( - n + 1 )}^{k - 1} \\ ⋮ & ⋮ & ⋮ & ⋮ & ⋱ & ⋮ \\ 1 & {0}^{1} & {0}^{2} & {0}^{3} & … & {0}^{k - 1}\end{matrix} ) .$$

Alternatively, the first high-order coefficient matrix may be a preset matrix, and after acquiring the first high-order coefficient matrix, the terminal device may determine the high-order information according to the following formula:

$$JA = B ,$$

where J is the first high-order coefficient matrix, B is the first motion information, and A is the high-order information. In this case, J and B are known to the terminal device. After determining the inverse matrix of J, the terminal device multiplies the inverse matrix of J by B to obtain the A matrix, which may be the high-order information of the first motion information. For example, the first motion information may include linear velocities and angular velocities. In response to B being a matrix composed of 3D vectors of n linear velocities, A obtained by the terminal device is high-order information related to the linear velocities; and in response to B being a matrix composed of 3D vectors of n angular velocities, A obtained by the terminal device is high-order information related to the angular velocities.

Alternatively, the terminal device may obtain the high-order information related to the first motion information by fitting it using a machine learning model (e.g., the terminal device may construct an nxk higher-order polynomial coefficient matrix related to model training, and then determine the higher-order information based on the model). The terminal device may also determine the higher-order information associated with the motion of the user during the first historical period by means of any feasible implementation mode, which is not limited by the embodiments of the present disclosure.

In S203, determining second motion information of the user during a future period according to the high-order information and the first motion information.

The second motion information may be motion information predicted by the terminal device. For example, the future period may be any duration (10 milliseconds, 15 milliseconds, 20 milliseconds, etc.), which is not limited by the embodiments of the present disclosure. In response to the future period being 10 milliseconds, the second motion information may be motion information predicted by the terminal device for the future 10 milliseconds, and in response to the future period being 20 milliseconds, the second motion information may be motion information predicted by the terminal device for the future 20 milliseconds.

The second motion information includes linear velocities of the user and angular velocities of the user during the future period. For example, the second motion information may include the linear velocities and angular velocities of the user's head predicted by the terminal device during the future period. For example, in response to the future period being 10 milliseconds, the second motion information may include the linear velocity and angular velocity for each millisecond in the future 10 milliseconds.

Alternatively, the higher-order information may include at least one of: (i) higher-order information of linear velocities, (ii) higher-order information of angular velocities. For example, the higher-order information of linear velocities may include motion information related to linear acceleration, and the higher-order information of angular velocities may include motion information related to angular acceleration, which is not limited by the embodiments of the present disclosure.

Alternatively, the terminal device may determine the second motion information of the user during the future period by means of the following feasible implementation mode: acquiring a second high-order coefficient matrix; and at least one of: (i) post-multiplying the second higher-order coefficient matrix by the higher-order information of linear velocity to obtain a linear velocity of the user during the future period; (b) post-multiplying the second higher-order coefficient matrix by the higher-order information of angular velocity to obtain an angular velocity of the user during the future period. In this way, the terminal device can accurately predict the pose of the user at the target moment in the future.

The second high-order coefficient matrix is used to predict the motion information. For example, the second high-order coefficient matrix may be a preset high-order polynomial coefficient matrix. For example, the second higher-order coefficient matrix may be expressed by the following formula:

$$R = ( \begin{matrix}1 & {1}^{1} & {1}^{2} & {1}^{3} & … & {1}^{k - 1} \\ ⋮ & ⋮ & ⋮ & ⋮ & ⋱ & ⋮ \\ 1 & {s}^{1} & {s}^{2} & {s}^{3} & … & {s}^{k - 1}\end{matrix} ) .$$

After acquiring the second high-order coefficient matrix, the terminal device may determine the linear velocity of the user during the future period according to the following formula:

$${P}_{v} = {RA}_{v} ,$$

where Pᵥ is the linear velocity of the user during the future period, R is the second high-order coefficient matrix, and Aᵥ is the high-order information of linear velocity.

The terminal device may determine the angular velocity of the user during the future period according to the following formula:

$${P}_{w} = {RA}_{w} ,$$

where P_{w} is the angular velocity of the user during the future period, R is the second high-order coefficient matrix, and A_{w} is the high-order information of angular velocity.

In S204, predicting a target pose of the user at a target moment according to the second motion information of the user during the future period and the current pose.

For example, the target moment may be a moment for which the pose is to be predicted. For example, in response to the terminal device predicting the pose of the user 10 milliseconds later, the target moment may be the moment 10 milliseconds after the current moment, and in response to the terminal device predicting the pose of the user 20 milliseconds later, the target moment may be the moment 20 milliseconds after the current moment.

Alternatively, the terminal device may determine the target moment according to the time lag between image rendering and screen display. For example, in response to the time lag of the terminal device between image rendering and screen display being 20 milliseconds, the target moment is the moment 20 milliseconds after the current moment, and in response to the time lag of the terminal device between image rendering and screen display being 40 milliseconds, the target moment is the moment 40 milliseconds after the current moment.

It should be noted that the terminal device may also determine the target moment by means of any feasible implementation mode, which is not limited by the embodiments of the present disclosure.

Alternatively, the target pose may be the pose of the user at the target moment. For example, the target pose may be a predicted position of the user's head at the target moment, the target pose may be a predicted orientation of the user's head at the target moment, and the target pose may also be the predicted position and orientation of the user's head at the target moment, which is not limited by the embodiments of the present disclosure. For example, in response to the target moment being the moment 20 milliseconds after the current moment, the target pose may be the position and/or orientation of the user's head 20 milliseconds later, as predicted by the terminal device at the current moment.

For example, the terminal device may predict the target pose of the user at the target moment by means of the following feasible implementation mode: acquiring real motion information and predicted motion information of the user during a second historical period; determining a prediction duration according to the real motion information and the predicted motion information; and predicting the target pose of the user at the target moment according to the second motion information, the current pose and the prediction duration.

For example, the second historical period may be the same as the first historical period, and the second historical period may also be different from the first historical period, which is not limited by the embodiments of the present disclosure.

The real motion information may include at least one of: (i) a plurality of real linear velocities, (ii) a plurality of real angular velocities. For example, in response to the second historical period being 10 milliseconds, the real motion information may be the real angular velocity and/or the real linear velocity for each millisecond during the second historical period. For example, in the practical application process, the IMU may collect angular velocities and/or linear velocities of the terminal device in real time, and the terminal device may store the angular velocities and/or linear velocities to obtain the real motion information during the second historical period.

The predicted motion information may include at least one of: (i) a plurality of predicted linear velocities, (ii) a plurality of predicted angular velocities. For example, the predicted motion information may be motion information predicted by the terminal device during the second historical period. For example, in response to the second historical period being 10 milliseconds, the terminal device may predict the linear velocity and/or angular velocity for each millisecond in the future 10 milliseconds at a moment 11 milliseconds before the current moment, and the terminal device may store the angular velocity and/or linear velocity to obtain the predicted motion information of the second historical period.

It should be noted that in response to the target pose being the position at the target moment, the real motion information may include real linear velocities, and the predicted motion information may include predicted linear velocities; in response to the target pose being the orientation at the target moment, the real motion information may include real angular velocities, and the predicted motion information may include predicted angular velocities; and in response to the target pose being the position and orientation at the target moment, the real motion information may include real linear velocities and real angular velocities, and the predicted motion information may include predicted linear velocities and predicted angular velocities.

Next, the predicted motion information and the real motion information will be described with reference to FIG. 3.

FIG. 3 is a schematic diagram of predicted motion information provided by the embodiments of the present disclosure. Here, FIG. 3 takes angular velocity as an example to explain the predicted motion information. Please refer to FIG. 3, which includes a timeline. The terminal device (not shown in FIG. 3) may predict the angular velocities in the future 5 milliseconds at the current moment. The angular velocity at the moment 1 millisecond from the current moment is angular velocity 1, the angular velocity at the moment 2 milliseconds from the current moment is angular velocity 2, the angular velocity at the moment 3 milliseconds from the current moment is angular velocity 3, the angular velocity at the moment 4 milliseconds from the current moment is angular velocity 4, and the angular velocity at the moment 5 milliseconds from the current moment is angular velocity 5.

Referring to FIG. 3, after 5 milliseconds from the current moment, the angular velocity 1, the angular velocity 2, the angular velocity 3, the angular velocity 4 and the angular velocity 5 are the predicted motion information during the second historical period. For example, within the last 5 milliseconds, the terminal device may obtain the angular velocities for each millisecond, including angular velocity a, angular velocity b, angular velocity c, angular velocity d, and angular velocity e, based on IMU data, and the angular velocity a, the angular velocity b, the angular velocity c, the angular velocity d and the angular velocity e may be the real motion information during the second historical period. In this way, the terminal device may accurately determine the prediction duration based on the real motion information and the predicted motion information.

Alternatively, the prediction duration may be an effective step size of the second motion information predicted by the terminal device. For example, because the high-order information is information acquired by the terminal device from the first motion information during the first historical period, and the high-order information may affect the motion information for a future duration (i.e. the prediction duration), the prediction duration may be an effective duration of the second motion information. Within the prediction duration, the accuracy of the second motion information is relatively high, and after the prediction duration, the accuracy of the second motion information is relatively low (however, the accuracy of the second motion information is still higher than that of the uniform motion information).

The prediction duration may include at least one of: (i) a linear velocity prediction duration, (ii) an angular velocity prediction duration; and the terminal device may determine the prediction duration according to the real motion information and the predicted motion information. For example, the terminal device may perform at least one of: (i) determining the linear velocity prediction duration according to a plurality of real linear velocities and a plurality of predicted linear velocities; (ii) determining the angular velocity prediction duration according to a plurality of real angular velocities and a plurality of predicted angular velocities.

For example, predicting, by the terminal device, the target pose of the user at the target moment according to the second motion information, the current pose and the prediction duration may include at least one of: (i) determining a plurality of first future moments during the future period according to the linear velocity prediction duration, and determining a target linear velocity corresponding to each first future moment in the second motion information; determining a target displacement according to a plurality of target linear velocities, the linear velocity prediction duration and a target duration between the target moment and the current moment; and predicting a position of the user at the target moment according to the current pose and the target displacement; (ii) determining a plurality of second future moments during the future period according to the angular velocity prediction duration, and determining a target angular velocity corresponding to each second future moment in the second motion information; determining a target rotation angle according to a plurality of target angular velocities, the angular velocity prediction duration and a target duration between the target moment and the current moment; and predicting an orientation of the user at the target moment according to the current pose and the target rotation angle.

The first future moment may be a moment during the future period. For example, in response to the future period being 20 milliseconds and the linear velocity prediction duration being 5 milliseconds, the number of the first future moments is 5, and the first future moments may include a moment 1 millisecond from now, a moment 2 milliseconds from now, a moment 3 milliseconds from now, a moment 4 milliseconds from now, and a moment 5 milliseconds from now.

The target linear velocity may be a linear velocity corresponding to the first future moment. For example, the terminal device may obtain the second motion information according to the high-order information and the first motion information. For example, the second motion information may include the predicted linear velocities for the next 20 milliseconds. In response to the first future moments being the moment 1 millisecond from now and the moment 2 milliseconds from now, the target linear velocities may be the predicted linear velocity for the moment 1 millisecond from now and the predicted linear velocity for the moment 2 milliseconds from now in the second motion information.

It should be noted that the terminal device may determine the first future moments and the target linear velocities by means of any feasible implementation mode, which is not limited by the embodiments of the present disclosure.

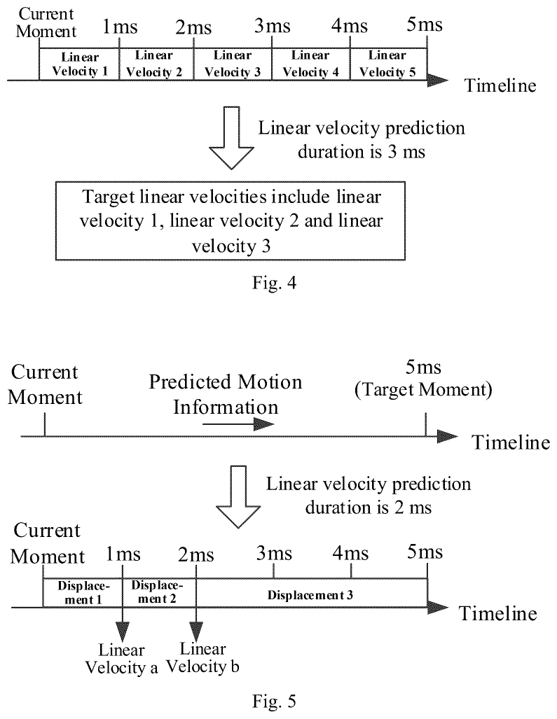

Next, the target linear velocity will be described with reference to FIG. 4.

FIG. 4 is a schematic diagram of a target linear velocity provided by the embodiments of the present disclosure. Please refer to FIG. 4, which includes a timeline. The terminal device (not shown in FIG. 4) may predict the linear velocities in the next 5 milliseconds at the current moment. The linear velocity at the moment 1 millisecond from the current moment is linear velocity 1, the linear velocity at the moment 2 milliseconds from the current moment is linear velocity 2, the linear velocity at the moment 3 milliseconds from the current moment is linear velocity 3, the linear velocity at the moment 4 milliseconds from the current moment is linear velocity 4, and the linear velocity at the moment 5 milliseconds from the current moment is linear velocity 5.

Referring to FIG. 4, in response to the linear velocity prediction duration being 3 milliseconds, the terminal device may determine that the first future moments include a moment 1 millisecond from now, a moment 2 milliseconds from now, a moment 3 milliseconds from now, and the terminal device may determine that the target linear velocities include linear velocity 1 (the angular velocity corresponding to the moment 1 millisecond from now), linear velocity 2 (the angular velocity corresponding to the moment 2 milliseconds from now) and linear velocity 3 (the angular velocity corresponding to the moment 3 milliseconds from now). In this way, the terminal device may accurately determine the effective linear velocity (target linear velocity), thus improving the accuracy of pose prediction.

The second future moment may be a moment during the future period. For example, in response to the future period being 20 milliseconds and the angular velocity prediction duration being 3 milliseconds, the number of the second future moments is 3, and the second future moments may include a moment 1 millisecond from now, a moment 2 milliseconds from now, and a moment 3 milliseconds from now.

The target angular velocity may be an angular velocity corresponding to the second future moment. For example, the terminal device may obtain the second motion information according to the high-order information and the first motion information. For example, the second motion information may include the predicted angular velocities for the next 20 milliseconds. In response to the second future moments being the moment 1 millisecond from now and the moment 2 milliseconds from now, the target angular velocities may be the predicted angular velocity for the moment 1 millisecond from now and the predicted angular velocity for the moment 2 milliseconds from now in the second motion information.

The target duration may be a duration between the target moment and the current moment. For example, in response to the target moment being a moment 20 milliseconds from now, the target duration may be 20 milliseconds. It should be noted that the terminal device may determine the target duration based on the time lag between image rendering and screen display, or determine the target duration by means of any feasible implementation mode, which is not limited by the embodiments of the present disclosure.

The target displacement may be a displacement of the user's head within the target duration. For example, in response to the target duration being 20 milliseconds, the target displacement may be the displacement of the user's head within 20 milliseconds, and in response to the target duration being 40 milliseconds, the target displacement may be the displacement of the user's head within 40 milliseconds.

The target rotation angle may be a rotation angle of the user's head within the target duration. For example, in response to the target duration being 20 milliseconds, the target rotation angle may be the relative rotation angle of the user's head within 20 milliseconds, and in response to the target duration being 40 milliseconds, the target rotation angle may be the relative rotation angle of the user's head within 40 milliseconds.

Alternatively, determining, by the terminal device, the target displacement according to the plurality of target linear velocities, the linear velocity prediction duration and the target duration between the target moment and the current moment may include: determining a first displacement according to the plurality of target linear velocities and the linear velocity prediction duration; determining a second displacement according to a target linear velocity corresponding to a last first future moment and the target duration; and determining a sum of the first displacement and the second displacement as the target displacement.

The first displacement may be a displacement corresponding to the plurality of target linear velocities within the linear velocity prediction duration. For example, the terminal device may determine the first displacement according to the following formula:

$$X = t * {v}_{1} + t * {v}_{2} + … + t * {v}_{n} ,$$

where X is the first displacement, t is a time period between adjacent first future moments (for example, in response to the first future moments being a moment 1 millisecond from now and a moment 2 milliseconds from now, t is 1 millisecond, and in the practical application process, because the IMU sampling interval is the same, the corresponding t for each target linear velocity is also the same), Un is the n-th target linear velocity, and n may indicate the linear velocity prediction duration (for example, in response to the linear velocity prediction duration being 5 milliseconds, n may be 5, and the number of the target linear velocities is also 5).

The second displacement may be the displacement corresponding to the target linear velocity at the last first future moment within the target duration. For example, because the linear velocity prediction duration is an effective prediction step size of linear velocity, during the future period, the terminal device may determine the linear velocity for another duration (target duration) beyond the prediction duration as the last target linear velocity within the prediction duration, and the terminal device may determine the displacement of the user's head during another duration beyond the prediction duration according to the target linear velocity and the target duration. For example, in the above-mentioned formula, in response to n being 5 and the future period being 20 milliseconds, the last target linear velocity is v₅, the target duration is 15 milliseconds, and the second displacement may be v₅*15 (in milliseconds).

Alternatively, after determining the first displacement and the second displacement, the terminal device may sum the first displacement and the second displacement to obtain the target displacement of the user's head during the future period. In this way, because the accuracy of the high-order information in the linear velocity related to the first displacement is relatively high, the accuracy of the first displacement is relatively high. Moreover, although the terminal device does not determine the linear velocities corresponding to each moment in the second displacement, the accuracy of the second displacement is relatively high because the target linear velocity for calculating the second displacement also includes the high-order information, thus improving the accuracy of the target displacement.

Next, the target displacement will be described with reference to FIG. 5.

FIG. 5 is a schematic diagram of a target displacement provided by the embodiments of the present disclosure. Please refer to FIG. 5 which includes a timeline. For example, the target moment is a moment 5 milliseconds from now, and the target duration between the current moment and the target moment is 5 milliseconds. The terminal device (not shown in FIG. 5) may predict the motion information during the future period. In response to the linear velocity prediction duration being 2 milliseconds, the terminal device may determine that the first future moments include a moment 1 millisecond from now and a moment 2 milliseconds from now, and the target linear velocities include the linear velocity a at the moment 1 millisecond from now and the linear velocity b at the moment 2 milliseconds from now.

Referring to FIG. 5, the terminal device may obtain displacement 1 according to linear velocity a and 1 millisecond, and obtain displacement 2 according to linear velocity b and 1 millisecond, and the sum of displacement 1 and displacement 2 is the first displacement. The terminal device may determine displacement 3 (i.e. the second displacement) according to linear velocity b and 3 milliseconds, and the terminal device may sum displacement 1, displacement 2 and displacement 3 to obtain the target displacement of the user's head during the future 5 milliseconds. In this way, the linear velocity related to the target displacement includes high-order information, so the accuracy of the target displacement is relatively high, thus improving the accuracy of pose prediction.

Alternatively, determining the target rotation angle according to the plurality of target angular velocities, the angular velocity prediction duration and the target duration between the target moment and the current moment may include: determining a first rotation angle according to the plurality of target angular velocities and the angular velocity prediction duration; determining a second rotation angle according to a target angular velocity corresponding to a last second future moment and the target duration; and determining a sum of the first rotation angle and the second rotation angle as the target rotation angle.

The first rotation angle may be a rotation angle corresponding to the plurality of target angular velocities within the angular velocity prediction duration. For example, the terminal device may determine the first rotation angle according to the following formula:

$$C = EXP ( {w}_{1} t ) ⊕ EXP ( {w}_{2} t ) ⊕ … ⊕ EXP ( {w}_{n} t ) ,$$

where C is the first rotation angle, t is a time period between adjacent second future moments (for example, in response to the second future moments being a moment 1 millisecond from now and a moment 2 milliseconds from now, t is 1 millisecond, and in the practical application process, because the IMU sampling interval is the same, the corresponding t for each target angular velocity is also the same), Wn is the n-th target angular velocity, and n may indicate the angular velocity prediction duration (for example, in response to the angular velocity prediction duration being 3 milliseconds, n may be 3, and the number of the target angular velocities is also 5).

The second rotation angle may be the rotation angle corresponding to the target angular velocity at the last second future moment within the target duration. For example, because the angular velocity prediction duration is an effective prediction step size of angular velocity, during the future period, the terminal device may determine the angular velocity for another duration (target duration) beyond the prediction duration as the last target angular velocity within the prediction duration, and the terminal device may determine the rotation angle of the user's head during another duration beyond the prediction duration according to the target angular velocity and the target duration. For example, in the above-mentioned formula, in response to n being 3 and the future period being 20 milliseconds, the last target linear velocity is w₃, the target duration is 17 milliseconds, and the second rotation angle may be EXP(w₃t₀), where t₀ is 17 milliseconds.

Alternatively, after determining the first rotation angle and the second rotation angle, the terminal device may sum the first rotation angle and the second rotation angle to obtain the target rotation angle of the user's head during the future period. In this way, because the accuracy of the high-order information in the angular velocity related to the first rotation angle is relatively high, the accuracy of the first rotation angle is relatively high. Moreover, although the terminal device does not determine the angular velocity corresponding to each moment in the second rotation angle, the accuracy of the second rotation angle is relatively high because the target angular velocity for calculating the second rotation angle also includes the high-order information, thus improving the accuracy of the target rotation angle.

Alternatively, in response to the pose being the position, the terminal device may predict the target pose of the user at the target moment according to the current pose and the target displacement. For example, the terminal device may sum the current position and the target displacement to obtain the target position of the user at the target moment (the direction may be the default moving direction, such as the front of the user).

Alternatively, in response to the pose being the orientation, the terminal device may predict the target pose of the user at the target moment according to the current pose and the target rotation angle. For example, the terminal device may sum the current orientation and the target rotation angle to obtain the target orientation of the user at the target moment (that is, the target pose).

Alternatively, in response to the pose being the position and orientation, the terminal device may obtain the position of the user at the target moment according to the position in the current pose and the target displacement, obtain the orientation of the user at the target moment according to the orientation in the current pose and the target rotation angle, and then obtain the target pose of the user at the target moment according to the position and orientation at the target moment.

The embodiments of the present disclosure provide a pose prediction method. The terminal device may acquire first motion information of a user during a first historical period and the current pose of the user, acquire a first high-order coefficient matrix, determine an inverse matrix of the first high-order coefficient matrix, and determine a product of the inverse matrix of the first high-order coefficient matrix and the first motion information as high-order information; acquire a second high-order coefficient matrix; post-multiply the second higher-order coefficient matrix by the higher-order information of linear velocities to obtain linear velocities of the user during the future period; post-multiply the second higher-order coefficient matrix by the higher-order information of angular velocities to obtain angular velocities of the user during the future period, so as to obtain second motion information; acquire real motion information and predicted motion information of the user during a second historical period; determine a prediction duration according to the real motion information and the predicted motion information; and predict the target pose of the user at the target moment according to the second motion information, the current pose and the prediction duration. In this way, because the second motion information may include the high-order information of the motion of the user during the historical period, and the high-order information may accurately indicate the non-uniform motion of the user, the terminal device may accurately predict the target pose of the user at the target moment based on the second motion information, thereby improving the accuracy of pose prediction.

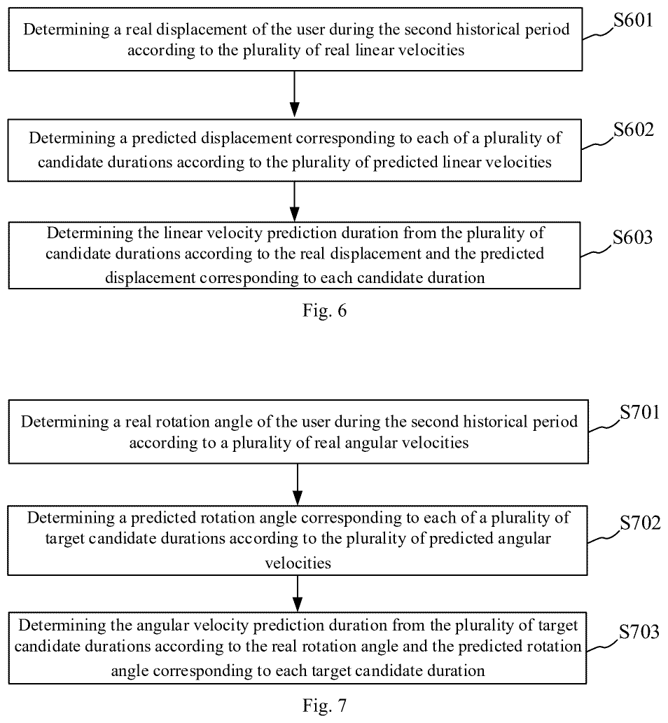

Based on the embodiment shown in FIG. 2, in the above-mentioned pose prediction method, the prediction duration may include an angular velocity prediction duration and a linear velocity prediction duration. Next, with reference to FIG. 6-FIG. 7, the method for determining the linear velocity prediction duration according to the plurality of real linear velocities and the plurality of predicted linear velocities and the method for determining the angular velocity prediction duration according to the plurality of real angular velocities and the plurality of predicted angular velocities will be further explained.

FIG. 6 is a schematic diagram of a method for determining a linear velocity prediction duration provided by the embodiments of the present disclosure. Referring to FIG. 6, the method includes the following steps.

In S601, determining a real displacement of the user during the second historical period according to the plurality of real linear velocities.

The real displacement may be the real displacement of the user during the second historical period. For example, in response to the second historical period being 10 milliseconds, the real displacement may be the displacement of the user in the past 10 milliseconds, and in response to the second historical period being 20 milliseconds, the real displacement may be the displacement of the user in the past 20 milliseconds.

Alternatively, the terminal device may determine the plurality of real linear velocities according to the data collected by one or more sensors. For example, the terminal device may determine the real linear velocity corresponding to each millisecond during the second historical period according to the data collected by the IMU.

Alternatively, the terminal device may determine the real displacement of the user during the second historical period according to each real linear velocity and the corresponding duration corresponding to each real linear velocity. For example, in response to the second historical period being 3 milliseconds (only as an example), the terminal device determines that the second historical period includes 3 real linear velocities (the IMU determines one real linear velocity every 1 millisecond), and the terminal device may determine the real displacement as real linear velocity 1*1 millisecond+real linear velocity 2*1 millisecond+real linear velocity 3*1 millisecond.

It should be noted that the terminal device may determine the real displacement of the user during the second historical period by means of any feasible implementation mode, which is not limited by the embodiments of the present disclosure.

In S602, determining a predicted displacement corresponding to each of a plurality of candidate durations according to the plurality of predicted linear velocities.

Here, the candidate duration is less than or equal to the duration between the current moment and the target moment. For example, in response to the terminal device predicting the pose of the user's head after 20 milliseconds, the duration between the current moment and the target moment is 20 milliseconds, and the candidate duration may be less than or equal to 20 milliseconds. For example, in response to the duration between the current moment and the target moment being 5 milliseconds, the candidate duration may be 1 millisecond, 2 milliseconds, 3 milliseconds, 4 milliseconds, or 5 milliseconds.

It should be noted that the terminal device may also determine the candidate duration by means of any feasible implementation mode, which is not limited by the embodiments of the present disclosure.

The predicted displacement corresponding to the candidate duration may be a sum of a displacement related to the candidate duration and a displacement related to another duration during the second historical period.

For any candidate duration, the terminal device may determine the predicted displacement corresponding to the candidate duration by means of the following feasible implementation mode: determining a plurality of first moments during the second historical period according to the candidate duration; determining a first predicted displacement according to a predicted linear velocity corresponding to each first moment; determining a difference between a duration of the second historical period and the candidate duration as a remaining duration; determining a second predicted displacement according to a predicted linear velocity of a last first moment among the plurality of first moments and the remaining duration; and determining a sum of the first predicted displacement and the second predicted displacement as the predicted displacement.

Here, the plurality of first moments are moments within the candidate duration during the second historical period. For example, in response to the second historical period being 10 milliseconds and the candidate duration being 4 milliseconds, the first moments may include the moment at the first millisecond, the moment at the second millisecond, the moment at the third millisecond, and the moment at the fourth millisecond.

The first predicted displacement may be a displacement within the candidate duration. For example, in response to the candidate duration being 4 milliseconds, the first predicted displacement may be a displacement determined by the terminal device based on the 4 predicted linear velocities related to the candidate duration and the candidate duration. For example, in response to the candidate duration being 3 milliseconds, the predicted linear velocity at the moment of the first millisecond is linear velocity 1, the predicted linear velocity at the moment of the second millisecond is linear velocity 2, and the predicted linear velocity at the moment of the third millisecond is linear velocity 3, the terminal device determines that the first predicted displacement may be linear velocity 1*1 millisecond+linear velocity 2*1 millisecond+linear velocity 3*1 millisecond.

It should be noted that the terminal device may also determine the first predicted displacement by means of any feasible implementation mode (for example, the first predicted displacement may be determined according to an average linear velocity within the candidate duration and the candidate duration), which is not limited by the embodiments of the present disclosure.

The remaining duration may be the difference between the duration of the second historical period and the candidate duration. For example, in response to the second historical period being 10 milliseconds and the candidate duration being 3 milliseconds, the remaining duration is 7 milliseconds; and in response to the second historical period being 20 milliseconds and the candidate duration being 5 milliseconds, the remaining duration is 15 milliseconds.

The second predicted displacement may be a displacement related to the remaining duration. For example, the terminal device may determine the predicted linear velocity of the last first moment among the plurality of first moments as the linear velocity corresponding to the remaining duration, and then calculate the second predicted displacement related to the remaining duration according to the predicted linear velocity and the remaining duration. For example, in response to the second historical period being 10 milliseconds, the candidate duration being 3 milliseconds, the remaining duration being 7 milliseconds, the predicted linear velocity at the moment of the first millisecond being linear velocity 1, the predicted linear velocity at the moment of the second millisecond being linear velocity 2, and the predicted linear velocity at the moment of the third millisecond being linear velocity 3, the terminal device may determine the predicted linear velocity at the last first moment as linear velocity 3. Therefore, the terminal device may determine the second predicted displacement as linear velocity 3*7 milliseconds.

Alternatively, after obtaining the first predicted displacement and the second predicted displacement, the terminal device may determine the sum of the first predicted displacement and the second predicted displacement as the predicted displacement. In this way, the terminal device may acquire a plurality of candidate durations in advance, then calculate the predicted displacement corresponding to each candidate duration, then determine the candidate duration with the highest accuracy among the plurality of candidate durations according to the differences between the plurality of predicted displacements and the real displacement, and then determine the candidate duration as the linear velocity prediction duration. In this way, the linear velocity prediction duration can be accurately determined.

In S603, determining the linear velocity prediction duration from the plurality of candidate durations according to the real displacement and the predicted displacement corresponding to each candidate duration.

After obtaining the plurality of predicted displacements, the terminal device may determine the linear velocity prediction duration according to the differences between the real displacement and the plurality of predicted displacements. For example, the terminal device may determine the linear velocity prediction duration from the plurality of candidate durations by means of the following feasible implementation mode: determining an absolute value of a difference between the predicted displacement corresponding to each candidate duration and the real displacement; and determining the candidate duration with the smallest absolute value of the difference as the linear velocity prediction duration.

For example, the real displacement is displacement A, the predicted displacement corresponding to the candidate duration 1 is displacement B, and the predicted displacement corresponding to the candidate duration 2 is displacement C. In response to the absolute value of the difference between displacement A and displacement B being less than the absolute value of the difference between displacement A and displacement C, the terminal device may determine the candidate duration 1 as the linear velocity prediction duration. In response to the absolute value of the difference between displacement A and displacement B being greater than the absolute value of the difference between displacement A and displacement C, the terminal device may determine the candidate duration 2 as the linear velocity prediction duration. In response to the absolute value of the difference between displacement A and displacement B being equal to the absolute value of the difference between displacement A and displacement C, the terminal device may determine the larger one of the candidate duration 1 and the candidate duration 2 as the linear velocity prediction duration.

For example, in response to the first historical period being 5 milliseconds, the candidate duration may be 1 millisecond, 2 milliseconds, 3 milliseconds, 4 milliseconds, or 5 milliseconds. The terminal device may determine that the real displacement during the first historical period is 10 centimeters. In response to the candidate duration being 1 millisecond, the terminal device may calculate the predicted displacement corresponding to the second historical period to be 11 centimeters. In response to the candidate duration being 2 milliseconds, the terminal device may calculate the predicted displacement corresponding to the second historical period to be 12 centimeters. In response to the candidate duration being 3 milliseconds, the terminal device may calculate the predicted displacement corresponding to the second historical period as 9 centimeters. In response to the candidate duration being 4 milliseconds, the terminal device may calculate the predicted displacement corresponding to the second historical period as 13 centimeters. In response to the candidate duration being 5 milliseconds, the terminal device may calculate the predicted displacement corresponding to the second historical period as 14 centimeters. In this way, the terminal device may determine that when the candidate duration is 1 millisecond and the candidate duration is 3 milliseconds, the difference between the predicted displacement and the real displacement is minimized, and because 3 milliseconds is greater than 1 millisecond, the terminal device may then determine the linear velocity prediction duration to be 3 milliseconds. In this way, the accuracy of the linear velocity prediction duration is relatively high, and therefore, the terminal device may accurately predict the displacement of the user's head during the future period. Consequently, the terminal device may accurately predict the pose of the user's head at the target moment, thus improving the accuracy of pose prediction.

For example, in response to a t-th IMU moment, the prediction result of s linear velocities before s IMU moments may be expressed as {\hat{V}ᵢ₍ₜ₋ₛ₎}(1≤i≤s), and the corresponding real linear velocity is expressed as {Vᵢ₍ₜ₎}(−s+1≤i≤0). In response to the duration between the target moment and the current moment being d IMU moments (d≥s), the terminal device may obtain an optimal predicted step size s IMU moments ago according to the following formula:

$${l}^{*} = arg min ‖ {\sum }_{i = 1}^{l} ( {\hat{V}}_{i ( t - s )} ) + {\hat{V}}_{l ( t - s )} ( d - l ) - ( {\sum }_{i = - s + 1}^{0} {V}_{i ( t )} + {V}_{0 ( t )} ( d - s ) ) ‖ ,$$

where 1 is greater than or equal to 1 and less than or equal to s.

The embodiments of the present disclosure provide a method for determining the linear velocity prediction duration, which includes the following steps: determining a real displacement of the user during the second historical period according to the plurality of real linear velocities; for any candidate duration, determining a plurality of first moments during the second historical period according to the candidate duration; determining a first predicted displacement according to the predicted linear velocity corresponding to each first moment; determining a difference between a duration of the second historical period and the candidate duration as a remaining duration; determining a second predicted displacement according to the predicted linear velocity of the last first moment among the plurality of first moments and the remaining duration; determining a sum of the first predicted displacement and the second predicted displacement as the predicted displacement; and determining the linear velocity prediction duration from the plurality of candidate durations according to the real displacement and the predicted displacement corresponding to each candidate duration. In this way, the terminal device may repeatedly calculate the difference between the predicted displacement and the real displacement for each candidate duration, and then determine the candidate duration with the smallest difference as the linear velocity prediction duration, thereby improving the accuracy of the linear velocity prediction duration.

Next, with reference to FIG. 7, a method for determining the angular velocity prediction duration based on a plurality of real angular velocities and a plurality of predicted angular velocities will be described in detail.

FIG. 7 is a schematic diagram of a method for determining an angular velocity prediction duration provided by the embodiments of the present disclosure. Referring to FIG. 7, the method includes the following steps.

In S701, determining a real rotation angle of the user during the second historical period according to a plurality of real angular velocities.

The real rotation angle may be the real rotation angle of the user during the second historical period. For example, in response to the second historical period being 10 milliseconds, the real rotation angle may be the relative rotation angle of the user in the past 10 milliseconds, and in response to the second historical period being 20 milliseconds, the real rotation angle may be the relative rotation angle of the user in the past 20 milliseconds.

Alternatively, the terminal device may determine the plurality of real angular velocities according to the data collected by one or more sensors. For example, the terminal device may determine the real angular velocity corresponding to each millisecond during the second historical period according to the data collected by the IMU.

Alternatively, the terminal device may determine the real rotation angle of the user during the second historical period according to each real angular velocity and the corresponding duration of each real angular velocity. For example, in response to the second historical period being 3 milliseconds (only as an example), the terminal device determines that the second historical period includes 3 real angular velocities (the IMU determines one real angular velocity every 1 millisecond), and the terminal device may determine the real rotation angle as Exp (real angular velocity 1*1 millisecond)⊕Exp (real angular velocity 2*1 millisecond)⊕Exp (real angular velocity 3*1 millisecond), where the angular velocity may be represented using a unit quaternion, and ⊕ is the multiplication of two unit quaternions.

It should be noted that the terminal device may determine the real rotation angle of the user during the second historical period by means of any feasible implementation mode, which is not limited by the embodiments of the present disclosure.

In S702, determining a predicted rotation angle corresponding to each of a plurality of target candidate durations according to the plurality of predicted angular velocities.

Here, the target candidate duration is less than or equal to the duration between the current moment and the target moment. For example, in response to the terminal device predicting the pose of the user's head 20 milliseconds later, the duration between the current moment and the target moment is 20 milliseconds, and the target candidate duration may be less than or equal to 20 milliseconds. For example, in response to the duration between the current moment and the target moment being 5 milliseconds, the target candidate duration may be 1 millisecond, 2 milliseconds, 3 milliseconds, 4 milliseconds, or 5 milliseconds.

It should be noted that the terminal device may also determine the target candidate duration by means of any feasible implementation mode, which is not limited by the embodiments of the present disclosure.

For example, the predicted rotation angle corresponding to the target candidate duration may be a sum of the rotation angle related to the target candidate duration and the rotation angle related to another duration during the second historical period.

For any target candidate duration, the terminal device may determine the predicted rotation angle corresponding to the target candidate duration by means of the following feasible implementation mode: determining a plurality of second moments during the second historical period according to the target candidate duration; determining a first predicted rotation angle according to the predicted angular velocity corresponding to each second moment; determining a difference between a duration of the second historical period and the target candidate duration as a target remaining duration; determining a second predicted rotation angle according to the predicted angular velocity of a last second moment among the plurality of second moments and the target remaining duration; and determining a sum of the first predicted rotation angle and the second predicted rotation angle as the predicted rotation angle.

Here, the plurality of second moments are moments within the target candidate duration during the second historical period. For example, in response to the second historical period being 10 milliseconds and the target candidate duration being 3 milliseconds, the second moments may include the moment at the first millisecond, the moment at the second millisecond, and the moment at the third millisecond.

Here, the first predicted rotation angle may be a rotation angle within the target candidate duration. For example, in response to the target candidate duration being 3 milliseconds, the first predicted rotation angle may be a rotation angle determined by the terminal device based on 3 predicted angular velocities related to the target candidate duration and the target candidate duration.

It should be noted that the terminal device may also determine the first predicted rotation angle by means of any feasible implementation mode (for example, the first predicted rotation angle may be determined according to an average angular velocity within the target candidate duration and the target candidate duration), which is not limited by the embodiments of the present disclosure.

The target remaining duration may be the difference between the duration of the second historical period and the target candidate duration. For example, in response to the second historical period being 10 milliseconds and the target candidate duration being 3 milliseconds, the target remaining duration is 7 milliseconds; and in response to the second historical period being 20 milliseconds and the target candidate duration being 5 milliseconds, the target remaining duration is 15 milliseconds.

The second predicted rotation angle may be a rotation angle related to the target remaining duration. For example, the terminal device may determine the predicted angular velocity of the last second moment among the plurality of second moments as the angular velocity corresponding to the target remaining duration, and then calculate the second predicted rotation angle related to the target remaining duration according to the predicted angular velocity and the target remaining duration. For example, in response to the second historical period being 10 milliseconds, the target candidate duration being 3 milliseconds, the target remaining duration being 7 milliseconds, the predicted angular velocity at the moment of the first millisecond being angular velocity 1, the predicted angular velocity at the moment of the second millisecond being angular velocity 2, and the predicted angular velocity at the moment of the third millisecond being angular velocity 3, the terminal device may determine the predicted angular velocity at the last second moment as angular velocity 3. Therefore, the terminal device may determine the second predicted rotation angle as angular velocity 3*7 milliseconds.

Alternatively, the terminal device may determine the sum of the first predicted rotation angle and the second predicted rotation angle as the predicted rotation angle. In this way, the terminal device may determine the target candidate duration with the highest accuracy among the plurality of target candidate durations according to the differences between the plurality of predicted rotation angles and the real rotation angle, and then determine the target candidate duration as the angular velocity prediction duration, so that the angular velocity prediction duration can be accurately determined.

In S703, determining the angular velocity prediction duration from the plurality of target candidate durations according to the real rotation angle and the predicted rotation angle corresponding to each target candidate duration.

After obtaining the plurality of predicted rotation angles, the terminal device may determine the angular velocity prediction duration according to the differences between the real rotation angle and the plurality of predicted rotation angles. The terminal device may determine the angular velocity prediction duration from the plurality of target candidate durations by means of the following feasible implementation mode: determining an absolute value of a difference between the predicted rotation angle corresponding to each target candidate duration and the real rotation angle; and determining the target candidate duration with the smallest absolute value of the difference as the angular velocity prediction duration.

It should be noted that, after the terminal device obtains the real rotation angle and the predicted rotation angle corresponding to each target candidate duration, the method for determining the angular velocity prediction duration by the terminal device is similar to that for determining the linear velocity prediction duration by the terminal device, which will not be repeated here.

The embodiments of the present disclosure provide a method for determining the angular velocity prediction duration, which includes the following steps: determining a real rotation angle of the user during the second historical period according to the plurality of real angular velocities; for any target candidate duration, determining a plurality of first moments during the second historical period according to the target candidate duration; determining a first predicted rotation angle according to the predicted angular velocity corresponding to each first moment; determining a difference between a duration of the second historical period and the target candidate duration as a target remaining duration; determining a second predicted rotation angle according to the predicted angular velocity of a last first moment among the plurality of first moments and the target remaining duration; determining a sum of the first predicted rotation angle and the second predicted rotation angle as the predicted rotation angle; and determining the angular velocity prediction duration from the plurality of target candidate durations according to the real rotation angle and the predicted rotation angle corresponding to each target candidate duration. In this way, the terminal device may repeatedly calculate the difference between the predicted rotation angle and the real rotation angle for each target candidate duration, and then determine the target candidate duration with the smallest difference as the angular velocity prediction duration, thereby improving the accuracy of the angular velocity prediction duration.

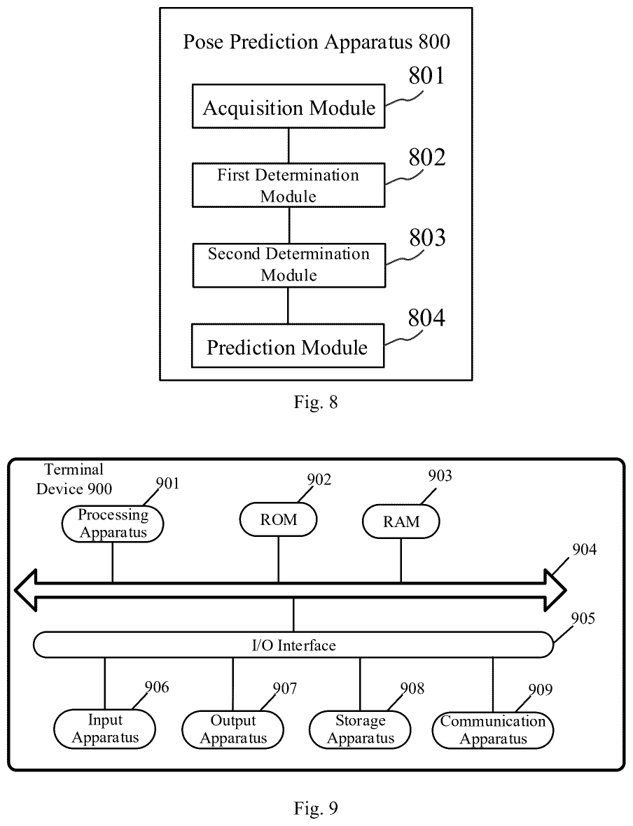

FIG. 8 is a schematic structural diagram of a pose prediction apparatus provided by the embodiments of the present disclosure. Please refer to FIG. 8, the pose prediction apparatus 800 includes an acquisition module 801, a first determination module 802, a second determination module 803, and a prediction module 804;
the acquisition module 801 is configured to acquire first motion information of a user during a first historical period and the current pose of the user;
the first determination module 802 is configured to determine high-order information associated with motion of the user during the first historical period according to the first motion information;
the second determination module 803 is configured to determine second motion information of the user during a future period according to the high-order information and the first motion information; and
the prediction module 804 is configured to predict a target pose of the user at a target moment according to the second motion information of the user during the future period and the current pose.

According to one or more embodiments of the present disclosure, the prediction module 804 is configured to:
acquire real motion information and predicted motion information of the user during a second historical period;
determine a prediction duration according to the real motion information and the predicted motion information; and
predict the target pose of the user at the target moment according to the second motion information, the current pose and the prediction duration.

According to one or more embodiments of the present disclosure, the prediction module 804 is configured to perform at least one of:
(i) determine a linear velocity prediction duration according to the plurality of real linear velocities and the plurality of predicted linear velocities;
(ii) determine an angular velocity prediction duration according to the plurality of real angular velocities and the plurality of predicted angular velocities.

According to one or more embodiments of the present disclosure, the prediction module 804 is configured to:
determine a real displacement of the user during the second historical period according to the plurality of real linear velocities;
determine a predicted displacement corresponding to each of a plurality of candidate durations according to the plurality of predicted linear velocities; and
determine the linear velocity prediction duration from the plurality of candidate durations according to the real displacement and the predicted displacement corresponding to each candidate duration.

According to one or more embodiments of the present disclosure, the prediction module 804 is configured to:
determine a plurality of first moments during the second historical period according to the candidate duration, in which the plurality of first moments are moments within the candidate duration during the second historical period;
determine a first predicted displacement according to a predicted linear velocity corresponding to each first moment;
determine a difference between a duration of the second historical period and the candidate duration as a remaining duration;
determine a second predicted displacement according to a predicted linear velocity of a last first moment among the plurality of first moments and the remaining duration; and
determine a sum of the first predicted displacement and the second predicted displacement as the predicted displacement.

According to one or more embodiments of the present disclosure, the prediction module 804 is configured to:
determine an absolute value of a difference between the predicted displacement corresponding to each candidate duration and the real displacement; and
determine a candidate duration with the smallest absolute value of the difference as the linear velocity prediction duration.

According to one or more embodiments of the present disclosure, the first determination module 802 is configured to:
acquire a first high-order coefficient matrix;
determine an inverse matrix of the first high-order coefficient matrix; and
determine a product of the inverse matrix of the first high-order coefficient matrix and the first motion information as the high-order information.

According to one or more embodiments of the present disclosure, the second determination module 803 is configured to:
acquire a second high-order coefficient matrix; and
at least one of: (i) post-multiply the second higher-order coefficient matrix by the higher-order information of linear velocity to obtain a linear velocity of the user during the future period; (ii) post-multiply the second higher-order coefficient matrix by the higher-order information of angular velocity to obtain an angular velocity of the user during the future period;
the second motion information includes the linear velocity of the user during the future period and the angular velocity of the user during the future period.

According to one or more embodiments of the present disclosure, the prediction module 804 is configured to perform at least one of:
(i) determine a plurality of first future moments during the future period according to the linear velocity prediction duration, and determine a target linear velocity corresponding to each first future moment in the second motion information;
determine a target displacement according a plurality of target linear velocities, the linear velocity prediction duration and a target duration between the target moment and a current moment; and
predict a position of the user at the target moment according to the current pose and the target displacement;
(ii) determine a plurality of second future moments during the future period according to the angular velocity prediction duration, and determine a target angular velocity corresponding to each second future moment in the second motion information;
determine a target rotation angle according to a plurality of target angular velocities, the angular velocity prediction duration and a target duration between the target moment and a current moment; and
predict an orientation of the user at the target moment according to the current pose and the target rotation angle.

According to one or more embodiments of the present disclosure, the prediction module 804 is configured to:
determine a first displacement according to the plurality of target linear velocities and the linear velocity prediction duration;
determine a second displacement according to a target linear velocity corresponding to a last first future moment and the target duration; and
determine a sum of the first displacement and the second displacement as the target displacement.

According to one or more embodiments of the present disclosure, the prediction module 804 is configured to:
determine a first rotation angle according to the plurality of target angular velocities and the angular velocity prediction duration;
determine a second rotation angle according to a target angular velocity corresponding to a last second future moment and the target duration; and
determine a sum of the first rotation angle and the second rotation angle as the target rotation angle.

The pose prediction apparatus provided by the embodiments of the present disclosure may be used to execute the technical solutions of the above-mentioned method embodiments. The implementation principles and technical effects are similar; therefore, the present embodiment will not be described in detail here.

FIG. 9 is a schematic structural diagram of a terminal device provided by the embodiments of the present disclosure. Referring to FIG. 9, FIG. 9 illustrates a schematic structural diagram of a terminal device 900 suitable for implementing the embodiments of the present disclosure. The terminal device in the embodiments of the present disclosure may include but is not limited to a mobile terminal such as a mobile phone, a notebook computer, a digital broadcasting receiver, a personal digital assistant (PDA), a portable Android device (PAD), a portable media player (PMP), a vehicle-mounted terminal (e.g., a vehicle-mounted navigation terminal), or the like, and a fixed terminal such as a digital TV, a desktop computer, or the like. The terminal device illustrated in FIG. 9 is merely an example, and should not pose any limitation to the functions and the range of use of the embodiments of the present disclosure.

As illustrated in FIG. 9, the terminal device 900 may include a processing apparatus 901 (e.g., a central processing unit, a graphics processing unit, etc.), which can perform various suitable actions and processing according to a program stored in a read-only memory (ROM) 902 or a program loaded from a storage apparatus 908 into a random-access memory (RAM) 903. The RAM 903 further stores various programs and data required for operations of the terminal device 900. The processing apparatus 901, the ROM 902, and the RAM 903 are interconnected through a bus 904. An input/output (I/O) interface 905 is also connected to the bus 904.

Usually, the following apparatuses may be connected to the I/O interface 905: an input apparatus 906 including, for example, a touch screen, a touch pad, a keyboard, a mouse, a camera, a microphone, an accelerometer, a gyroscope, or the like; an output apparatus 907 including, for example, a liquid crystal display (LCD), a loudspeaker, a vibrator, or the like; a storage apparatus 908 including, for example, a magnetic tape, a hard disk, or the like; and a communication apparatus 909. The communication apparatus 909 may allow the terminal device 900 to be in wireless or wired communication with other devices to exchange data. While FIG. 9 illustrates the terminal device 900 having various apparatuses, it should be understood that not all of the illustrated apparatuses are necessarily implemented or included. More or fewer apparatuses may be implemented or included alternatively.

Particularly, according to the embodiments of the present disclosure, the processes described above with reference to the flowcharts may be implemented as a computer software program. For example, the embodiments of the present disclosure include a computer program product, which includes a computer program carried by a non-transitory computer-readable medium. The computer program includes program code for performing the methods shown in the flowcharts. In such embodiments, the computer program may be downloaded online through the communication apparatus 909 and installed, or may be installed from the storage apparatus 908, or may be installed from the ROM 902. When the computer program is executed by the processing apparatus 901, the above-mentioned functions defined in the methods of some embodiments of the present disclosure are performed.

It should be noted that the above-mentioned computer-readable medium in the present disclosure may be a computer-readable signal medium or a computer-readable storage medium or any combination thereof. For example, the computer-readable storage medium may be, but not limited to, an electric, magnetic, optical, electromagnetic, infrared, or semiconductor system, apparatus or device, or any combination thereof. More specific examples of the computer-readable storage medium may include but not be limited to: an electrical connection with one or more wires, a portable computer disk, a hard disk, a random-access memory (RAM), a read-only memory (ROM), an erasable programmable read-only memory (EPROM or flash memory), an optical fiber, a compact disk read-only memory (CD-ROM), an optical storage device, a magnetic storage device, or any appropriate combination of them. In the present disclosure, the computer-readable storage medium may be any tangible medium containing or storing a program that can be used by or in combination with an instruction execution system, apparatus or device. In the present disclosure, the computer-readable signal medium may include a data signal that propagates in a baseband or as a part of a carrier and carries computer-readable program code. The data signal propagating in such a manner may take a plurality of forms, including but not limited to an electromagnetic signal, an optical signal, or any appropriate combination thereof. The computer-readable signal medium may also be any other computer-readable medium than the computer-readable storage medium. The computer-readable signal medium may send, propagate or transmit a program used by or in combination with an instruction execution system, apparatus or device. The program code contained on the computer-readable medium may be transmitted by using any suitable medium, including but not limited to an electric wire, a fiber-optic cable, radio frequency (RF) and the like, or any appropriate combination of them.

The above-mentioned computer-readable medium may be included in the above-mentioned terminal device, or may also exist alone without being assembled into the terminal device.

The above-mentioned computer-readable medium carries one or more programs, and when the one or more programs are executed by the terminal device, the terminal device is caused to perform the method according to the above-mentioned embodiments.

The embodiments of the present disclosure provide a computer-readable storage medium. The computer-readable storage medium stores computer-executable instructions, which, when executed by a processor, implement the various methods that may be involved in the above-mentioned embodiments.

The embodiments of the present disclosure further provide a computer program product, including a computer program, which, when executed by a processor, implements the various methods that may be involved in the above-mentioned embodiments.

The computer program code for performing the operations of the present disclosure may be written in one or more programming languages or a combination thereof. The above-mentioned programming languages include but are not limited to object-oriented programming languages such as Java, Smalltalk, C++, and also include conventional procedural programming languages such as the “C” programming language or similar programming languages. The program code may be executed entirely on the user's computer, partly on the user's computer, as a stand-alone software package, partly on the user's computer and partly on a remote computer, or entirely on the remote computer or server. In the scenario related to the remote computer, the remote computer may be connected to the user's computer through any type of network, including a local area network (LAN) or a wide area network (WAN), or the connection may be made to an external computer (for example, through the Internet using an Internet service provider).

The flowcharts and block diagrams in the drawings illustrate the architecture, function, and operation of possible implementations of systems, methods, and computer program products according to various embodiments of the present disclosure. In this regard, each block in the flowcharts or block diagrams may represent a module, a program segment, or a portion of code, including one or more executable instructions for implementing specified logical functions. It should also be noted that, in some alternative implementations, the functions noted in the blocks may also occur out of the order noted in the drawings. For example, two blocks shown in succession may, in fact, can be executed substantially concurrently, or the two blocks may sometimes be executed in a reverse order, depending upon the functionality involved. It should also be noted that, each block of the block diagrams and/or flowcharts, and combinations of blocks in the block diagrams and/or flowcharts, may be implemented by a dedicated hardware-based system that performs the specified functions or operations, or may also be implemented by a combination of dedicated hardware and computer instructions.

The modules or units involved in the embodiments of the present disclosure may be implemented in software or hardware. Among them, the name of the module or unit does not constitute a limitation of the unit itself under certain circumstances.

The functions described herein above may be performed, at least partially, by one or more hardware logic components. For example, without limitation, available exemplary types of hardware logic components include: a field programmable gate array (FPGA), an application specific integrated circuit (ASIC), an application specific standard product (ASSP), a system on chip (SOC), a complex programmable logical device (CPLD), etc.

In the context of the present disclosure, the machine-readable medium may be a tangible medium that may include or store a program for use by or in combination with an instruction execution system, apparatus or device. The machine-readable medium may be a machine-readable signal medium or a machine-readable storage medium. The machine-readable medium includes, but is not limited to, an electrical, magnetic, optical, electromagnetic, infrared, or semi-conductive system, apparatus or device, or any suitable combination of the foregoing. More specific examples of machine-readable storage medium include electrical connection with one or more wires, portable computer disk, hard disk, random-access memory (RAM), read-only memory (ROM), erasable programmable read-only memory (EPROM or flash memory), optical fiber, portable compact disk read-only memory (CD-ROM), optical storage device, magnetic storage device, or any suitable combination of the foregoing.

It should be noted that the modifications of “a,” “an,” “a plurality of,” or the like mentioned in the present disclosure are illustrative rather than restrictive, and those skilled in the art should understand that unless the context clearly indicates otherwise, these modifications should be understood as “one or more.”

The names of the messages or information exchanged between a plurality of apparatuses in the embodiments of the present disclosure are for illustrative purposes only and are not intended to limit the scope of these messages or information.

It may be understood that before using the technical solutions disclosed in the embodiments of the present disclosure, it is necessary to inform user(s) the types, using scope, and using scenarios of personal information involved in the present disclosure according to relevant laws and regulations in an appropriate manner and obtain the authorization of the user(s).

For example, in response to receiving a user's active request, a prompt message is sent to the user to clearly remind the user that the requested operation will require acquiring and using the user's personal information. Thus, users can selectively choose whether to provide personal information to the software or hardware such as an electronic device, an application, a server, or a storage medium that perform the operations of the technical solutions of the present disclosure according to the prompt message.

As an optional but non-restrictive implementation, in response to receiving the user's active request, sending the prompt message to the user may be done in the form of a pop-up window, where the prompt message may be presented in text. In addition, the pop-up window may further carry a selection control for users to choose between “agree” or “disagree” to provide the personal information to an electronic device.

It may be understood that the above-mentioned processes of informing and acquiring user authorization are only illustrative and do not limit the embodiments of the present disclosure. Other methods that comply with relevant laws and regulations may also be applied to the embodiments of the present disclosure.

It may be understood that the data involved in the technical solutions (including but not limited to the data itself, data acquisition or use) should comply with the requirements of corresponding laws, regulations and relevant provisions.

In a first aspect, the embodiments of the present disclosure provide a pose prediction method, which includes:
acquiring first motion information of a user during a first historical period and a current pose of the user;
determining high-order information associated with motion of the user during the first historical period according to the first motion information;
determining second motion information of the user during a future period according to the high-order information and the first motion information; and
predicting a target pose of the user at a target moment according to the second motion information of the user during the future period and the current pose.

According to one or more embodiments of the present disclosure, the predicting the target pose of the user at the target moment according to the second motion information of the user during the future period and the current pose includes:
acquiring real motion information and predicted motion information of the user during a second historical period;
determining a prediction duration according to the real motion information and the predicted motion information; and
predicting the target pose of the user at the target moment according to the second motion information, the current pose and the prediction duration.

According to one or more embodiments of the present disclosure, the real motion information includes at least one of: (i) a plurality of real linear velocities, (ii) a plurality of real angular velocities; the predicted motion information includes at least one of: (a) a plurality of predicted linear velocities, (b) a plurality of predicted angular velocities; and the determining the prediction duration according to the real motion information and the predicted motion information includes at least one of:
(A) determining a linear velocity prediction duration according to the plurality of real linear velocities and the plurality of predicted linear velocities;
(B) determining an angular velocity prediction duration according to the plurality of real angular velocities and the plurality of predicted angular velocities.

According to one or more embodiments of the present disclosure, the determining the linear velocity prediction duration according to the plurality of real linear velocities and the plurality of predicted linear velocities includes:
determining a real displacement of the user during the second historical period according to the plurality of real linear velocities;
determining a predicted displacement corresponding to each of a plurality of candidate durations according to the plurality of predicted linear velocities; and
determining the linear velocity prediction duration from the plurality of candidate durations according to the real displacement and the predicted displacement corresponding to each candidate duration.

According to one or more embodiments of the present disclosure, for any candidate duration among the plurality of candidate durations, determining a predicted displacement corresponding to the candidate duration according to the plurality of predicted linear velocities includes:
determining a plurality of first moments during the second historical period according to the candidate duration, in which the plurality of first moments are moments within the candidate duration during the second historical period;
determining a first predicted displacement according to a predicted linear velocity corresponding to each first moment;
determining a difference between a duration of the second historical period and the candidate duration as a remaining duration;
determining a second predicted displacement according to a predicted linear velocity of a last first moment among the plurality of first moments and the remaining duration; and
determining a sum of the first predicted displacement and the second predicted displacement as the predicted displacement.

According to one or more embodiments of the present disclosure, the determining the linear velocity prediction duration from the plurality of candidate durations according to the real displacement and the predicted displacement corresponding to each candidate duration includes:
determining an absolute value of a difference between the predicted displacement corresponding to each candidate duration and the real displacement; and
determining a candidate duration with a smallest absolute value of the difference as the linear velocity prediction duration.

According to one or more embodiments of the present disclosure, the determining high-order information associated with motion of the user during the first historical period according to the first motion information includes:
acquiring a first high-order coefficient matrix;
determining an inverse matrix of the first high-order coefficient matrix; and
determining a product of the inverse matrix of the first high-order coefficient matrix and the first motion information as the high-order information.

According to one or more embodiments of the present disclosure, the high-order information includes at least one of: (i) high-order information of linear velocity, (ii) high-order information of angular velocity; and the determining second motion information of the user during a future period according to the high-order information and the first motion information includes:
acquiring a second high-order coefficient matrix; and
at least one of: (a) post-multiplying the second higher-order coefficient matrix by the higher-order information of linear velocity to obtain a linear velocity of the user during the future period; (b) post-multiplying the second higher-order coefficient matrix by the higher-order information of angular velocity to obtain an angular velocity of the user during the future period,
in which the second motion information includes the linear velocity of the user during the future period and the angular velocity of the user during the future period.

According to one or more embodiments of the present disclosure, the prediction duration includes at least one of: (i) a linear velocity prediction duration, (ii) an angular velocity prediction duration; and the predicting the target pose of the user at the target moment according to the second motion information, the current pose and the prediction duration includes at least one of:
(a) determining a plurality of first future moments during the future period according to the linear velocity prediction duration, and determining a target linear velocity corresponding to each first future moment in the second motion information;
determining a target displacement according a plurality of target linear velocities, the linear velocity prediction duration and a target duration between the target moment and a current moment; and
predicting a position of the user at the target moment according to the current pose and the target displacement;
(b) determining a plurality of second future moments during the future period according to the angular velocity prediction duration, and determining a target angular velocity corresponding to each second future moment in the second motion information;
determining a target rotation angle according to a plurality of target angular velocities, the angular velocity prediction duration and a target duration between the target moment and a current moment; and
predicting an orientation of the user at the target moment according to the current pose and the target rotation angle.

According to one or more embodiments of the present disclosure, the determining the target displacement according to the plurality of target linear velocities, the linear velocity prediction duration and the target duration between the target moment and the current moment includes:
determining a first displacement according to the plurality of target linear velocities and the linear velocity prediction duration;
determining a second displacement according to a target linear velocity corresponding to a last first future moment and the target duration; and
determining a sum of the first displacement and the second displacement as the target displacement.

According to one or more embodiments of the present disclosure, the determining the target rotation angle according to the plurality of target angular velocities, the angular velocity prediction duration and the target duration between the target moment and the current moment includes:
determining a first rotation angle according to the plurality of target angular velocities and the angular velocity prediction duration;
determining a second rotation angle according to a target angular velocity corresponding to a last second future moment and the target duration; and
determining a sum of the first rotation angle and the second rotation angle as the target rotation angle.

In a second aspect, the embodiments of the present disclosure provide a pose prediction apparatus, which includes an acquisition module, a first determination module, a second determination module, and a prediction module;
the acquisition module is configured to acquire first motion information of a user during a first historical period and the current pose of the user;
the first determination module is configured to determine high-order information associated with motion of the user during the first historical period according to the first motion information;
the second determination module is configured to determine second motion information of the user during a future period according to the high-order information and the first motion information; and
the prediction module is configured to predict a target pose of the user at a target moment according to the second motion information of the user during the future period and the current pose.

According to one or more embodiments of the present disclosure, the prediction module is configured to:
acquire real motion information and predicted motion information of the user during a second historical period;
determine a prediction duration according to the real motion information and the predicted motion information; and
predict the target pose of the user at the target moment according to the second motion information, the current pose and the prediction duration.

According to one or more embodiments of the present disclosure, the prediction module is configured to perform at least one of:
(i) determine a linear velocity prediction duration according to the plurality of real linear velocities and the plurality of predicted linear velocities;
(ii) determine an angular velocity prediction duration according to the plurality of real angular velocities and the plurality of predicted angular velocities.

According to one or more embodiments of the present disclosure, the prediction module is configured to:
determine a real displacement of the user during the second historical period according to the plurality of real linear velocities;
determine a predicted displacement corresponding to each of a plurality of candidate durations according to the plurality of predicted linear velocities; and
determine the linear velocity prediction duration from the plurality of candidate durations according to the real displacement and the predicted displacement corresponding to each candidate duration.

According to one or more embodiments of the present disclosure, the prediction module is configured to:
determine a plurality of first moments during the second historical period according to the candidate duration, in which the plurality of first moments are moments within the candidate duration during the second historical period;
determine a first predicted displacement according to a predicted linear velocity corresponding to each first moment;
determine a difference between a duration of the second historical period and the candidate duration as a remaining duration;
determine a second predicted displacement according to a predicted linear velocity of a last first moment among the plurality of first moments and the remaining duration; and
determine a sum of the first predicted displacement and the second predicted displacement as the predicted displacement.

According to one or more embodiments of the present disclosure, the prediction module is configured to:
determine an absolute value of a difference between the predicted displacement corresponding to each candidate duration and the real displacement; and
determine a candidate duration with the smallest absolute value of the difference as the linear velocity prediction duration.

According to one or more embodiments of the present disclosure, the first determination module is configured to:
acquire a first high-order coefficient matrix;
determine an inverse matrix of the first high-order coefficient matrix; and
determine a product of the inverse matrix of the first high-order coefficient matrix and the first motion information as the high-order information.

According to one or more embodiments of the present disclosure, the second determination module is configured to:
acquire a second high-order coefficient matrix; and
at least one of: (i) post-multiply the second higher-order coefficient matrix by the higher-order information of linear velocity to obtain a linear velocity of the user during the future period; (ii) post-multiply the second higher-order coefficient matrix by the higher-order information of angular velocity to obtain an angular velocity of the user during the future period;
the second motion information includes the linear velocity of the user during the future period and the angular velocity of the user during the future period.

According to one or more embodiments of the present disclosure, the prediction module is configured to perform at least one of:
(i) determine a plurality of first future moments during the future period according to the linear velocity prediction duration, and determine a target linear velocity corresponding to each first future moment in the second motion information;
determine a target displacement according a plurality of target linear velocities, the linear velocity prediction duration and a target duration between the target moment and a current moment; and
predict a position of the user at the target moment according to the current pose and the target displacement;
(ii) determine a plurality of second future moments during the future period according to the angular velocity prediction duration, and determine a target angular velocity corresponding to each second future moment in the second motion information;
determine a target rotation angle according to a plurality of target angular velocities, the angular velocity prediction duration and a target duration between the target moment and a current moment; and
predict an orientation of the user at the target moment according to the current pose and the target rotation angle.

According to one or more embodiments of the present disclosure, the prediction module is configured to:
determine a first displacement according to the plurality of target linear velocities and the linear velocity prediction duration;
determine a second displacement according to a target linear velocity corresponding to a last first future moment and the target duration; and
determine a sum of the first displacement and the second displacement as the target displacement.

According to one or more embodiments of the present disclosure, the prediction module is configured to:
determine a first rotation angle according to the plurality of target angular velocities and the angular velocity prediction duration;
determine a second rotation angle according to a target angular velocity corresponding to a last second future moment and the target duration; and
determine a sum of the first rotation angle and the second rotation angle as the target rotation angle.

In a third aspect, the embodiments of the present disclosure provide a terminal device, which includes a processor and a memory;
the memory is configured to store computer-executable instructions; and
the processor is configured to execute the computer-executable instructions stored in the memory to implement the pose prediction method according to the first aspect or any embodiment of the first aspect.

In a fourth aspect, the embodiments of the present disclosure provide a non-transitory computer-readable storage medium, which stores computer-executable instructions, and a processor, when executing the computer-executable instructions, implements the pose prediction method according to the first aspect or any embodiment of the first aspect.

The above descriptions are merely preferred embodiments of the present disclosure and illustrations of the technical principles employed. Those skilled in the art should understand that the scope of disclosure involved in the present disclosure is not limited to the technical solutions formed by the specific combination of the above-mentioned technical features, and should also cover, without departing from the above-mentioned disclosed concept, other technical solutions formed by any combination of the above-mentioned technical features or their equivalents, such as technical solutions which are formed by replacing the above-mentioned technical features with the technical features disclosed in the present disclosure (but not limited to) with similar functions.

Additionally, although operations are depicted in a particular order, it should not be understood that these operations are required to be performed in a specific order as illustrated or in a sequential order. Under certain circumstances, multitasking and parallel processing may be advantageous. Likewise, although the above discussion includes several specific implementation details, these should not be interpreted as limitations on the scope of the present disclosure. Certain features that are described in the context of separate embodiments may also be implemented in combination in a single embodiment. Conversely, various features that are described in the context of a single embodiment may also be implemented in multiple embodiments separately or in any suitable sub-combinations.

Although the subject matter has been described in language specific to structural features and/or method logical actions, it should be understood that the subject matter defined in the appended claims is not necessarily limited to the specific features or actions described above. Rather, the specific features and actions described above are merely example forms of implementing the claims.

1. A pose prediction method, comprising:
acquiring first motion information of a user during a first historical period and a current pose of the user;
determining high-order information associated with motion of the user during the first historical period according to the first motion information;
determining second motion information of the user during a future period according to the high-order information and the first motion information; and
predicting a target pose of the user at a target moment according to the second motion information of the user during the future period and the current pose.

2. The method according to claim 1, wherein the predicting the target pose of the user at the target moment according to the second motion information of the user during the future period and the current pose comprises:
acquiring real motion information and predicted motion information of the user during a second historical period;
determining a prediction duration according to the real motion information and the predicted motion information; and
predicting the target pose of the user at the target moment according to the second motion information, the current pose and the prediction duration.

3. The method according to claim 2, wherein the real motion information comprises at least one of: (i) a plurality of real linear velocities, (ii) a plurality of real angular velocities; the predicted motion information comprises at least one of: (a) a plurality of predicted linear velocities, (b) a plurality of predicted angular velocities; and the determining the prediction duration according to the real motion information and the predicted motion information comprises at least one of:
(A) determining a linear velocity prediction duration according to the plurality of real linear velocities and the plurality of predicted linear velocities;
(B) determining an angular velocity prediction duration according to the plurality of real angular velocities and the plurality of predicted angular velocities.

4. The method according to claim 3, wherein the determining the linear velocity prediction duration according to the plurality of real linear velocities and the plurality of predicted linear velocities comprises:
determining a real displacement of the user during the second historical period according to the plurality of real linear velocities;
determining a predicted displacement corresponding to each of a plurality of candidate durations according to the plurality of predicted linear velocities; and
determining the linear velocity prediction duration from the plurality of candidate durations according to the real displacement and the predicted displacement corresponding to each candidate duration.

5. The method according to claim 4, wherein for any candidate duration among the plurality of candidate durations, determining a predicted displacement corresponding to the candidate duration according to the plurality of predicted linear velocities comprises:
determining a plurality of first moments during the second historical period according to the candidate duration, wherein the plurality of first moments are moments within the candidate duration during the second historical period;
determining a first predicted displacement according to a predicted linear velocity corresponding to each first moment;
determining a difference between a duration of the second historical period and the candidate duration as a remaining duration;
determining a second predicted displacement according to a predicted linear velocity of a last first moment among the plurality of first moments and the remaining duration; and
determining a sum of the first predicted displacement and the second predicted displacement as the predicted displacement.

6. The method according to claim 4, wherein the determining the linear velocity prediction duration from the plurality of candidate durations according to the real displacement and the predicted displacement corresponding to each candidate duration comprises:
determining an absolute value of a difference between the predicted displacement corresponding to each candidate duration and the real displacement; and
determining a candidate duration with a smallest absolute value of the difference as the linear velocity prediction duration.

7. The method according to claim 1, wherein the determining high-order information associated with motion of the user during the first historical period according to the first motion information comprises:
acquiring a first high-order coefficient matrix;
determining an inverse matrix of the first high-order coefficient matrix; and
determining a product of the inverse matrix of the first high-order coefficient matrix and the first motion information as the high-order information.

8. The method according to claim 2, wherein the determining high-order information associated with motion of the user during the first historical period according to the first motion information comprises:
acquiring a first high-order coefficient matrix;
determining an inverse matrix of the first high-order coefficient matrix; and
determining a product of the inverse matrix of the first high-order coefficient matrix and the first motion information as the high-order information.

9. The method according to claim 3, wherein the determining high-order information associated with motion of the user during the first historical period according to the first motion information comprises:
acquiring a first high-order coefficient matrix;
determining an inverse matrix of the first high-order coefficient matrix; and
determining a product of the inverse matrix of the first high-order coefficient matrix and the first motion information as the high-order information.

10. The method according to claim 4, wherein the determining high-order information associated with motion of the user during the first historical period according to the first motion information comprises:
acquiring a first high-order coefficient matrix;
determining an inverse matrix of the first high-order coefficient matrix; and
determining a product of the inverse matrix of the first high-order coefficient matrix and the first motion information as the high-order information.

11. The method according to claim 5, wherein the determining high-order information associated with motion of the user during the first historical period according to the first motion information comprises:
acquiring a first high-order coefficient matrix;
determining an inverse matrix of the first high-order coefficient matrix; and
determining a product of the inverse matrix of the first high-order coefficient matrix and the first motion information as the high-order information.

12. The method according to claim 6, wherein the determining high-order information associated with motion of the user during the first historical period according to the first motion information comprises:
acquiring a first high-order coefficient matrix;
determining an inverse matrix of the first high-order coefficient matrix; and
determining a product of the inverse matrix of the first high-order coefficient matrix and the first motion information as the high-order information.

13. The method according to claim 1, wherein the high-order information comprises at least one of: (i) high-order information of linear velocity, (ii) high-order information of angular velocity; and the determining second motion information of the user during a future period according to the high-order information and the first motion information comprises:
acquiring a second high-order coefficient matrix; and
at least one of: (a) post-multiplying the second higher-order coefficient matrix by the higher-order information of linear velocity to obtain a linear velocity of the user during the future period; (b) post-multiplying the second higher-order coefficient matrix by the higher-order information of angular velocity to obtain an angular velocity of the user during the future period,
wherein the second motion information comprises the linear velocity of the user during the future period and the angular velocity of the user during the future period.

14. The method according to claim 2, wherein the high-order information comprises at least one of: (i) high-order information of linear velocity, (ii) high-order information of angular velocity; and the determining second motion information of the user during a future period according to the high-order information and the first motion information comprises:
acquiring a second high-order coefficient matrix; and
at least one of: (a) post-multiplying the second higher-order coefficient matrix by the higher-order information of linear velocity to obtain a linear velocity of the user during the future period; (b) post-multiplying the second higher-order coefficient matrix by the higher-order information of angular velocity to obtain an angular velocity of the user during the future period,
wherein the second motion information comprises the linear velocity of the user during the future period and the angular velocity of the user during the future period.

15. The method according to claim 3, wherein the high-order information comprises at least one of: (i) high-order information of linear velocity, (ii) high-order information of angular velocity; and the determining second motion information of the user during a future period according to the high-order information and the first motion information comprises:
acquiring a second high-order coefficient matrix; and
at least one of: (a) post-multiplying the second higher-order coefficient matrix by the higher-order information of linear velocity to obtain a linear velocity of the user during the future period; (b) post-multiplying the second higher-order coefficient matrix by the higher-order information of angular velocity to obtain an angular velocity of the user during the future period,
wherein the second motion information comprises the linear velocity of the user during the future period and the angular velocity of the user during the future period.

16. The method according to claim 2, wherein the prediction duration comprises at least one of: (i) a linear velocity prediction duration, (ii) an angular velocity prediction duration; and the predicting the target pose of the user at the target moment according to the second motion information, the current pose and the prediction duration comprises at least one of:
(a) determining a plurality of first future moments during the future period according to the linear velocity prediction duration, and determining a target linear velocity corresponding to each first future moment in the second motion information;
determining a target displacement according a plurality of target linear velocities, the linear velocity prediction duration and a target duration between the target moment and a current moment; and
predicting a position of the user at the target moment according to the current pose and the target displacement;
(b) determining a plurality of second future moments during the future period according to the angular velocity prediction duration, and determining a target angular velocity corresponding to each second future moment in the second motion information;
determining a target rotation angle according to a plurality of target angular velocities, the angular velocity prediction duration and a target duration between the target moment and a current moment; and
predicting an orientation of the user at the target moment according to the current pose and the target rotation angle.

17. The method according to claim 16, wherein the determining the target displacement according to the plurality of target linear velocities, the linear velocity prediction duration and the target duration between the target moment and the current moment comprises:
determining a first displacement according to the plurality of target linear velocities and the linear velocity prediction duration;
determining a second displacement according to a target linear velocity corresponding to a last first future moment and the target duration; and
determining a sum of the first displacement and the second displacement as the target displacement.

18. The method according to claim 16, wherein the determining the target rotation angle according to the plurality of target angular velocities, the angular velocity prediction duration and the target duration between the target moment and the current moment comprises:
determining a first rotation angle according to the plurality of target angular velocities and the angular velocity prediction duration;
determining a second rotation angle according to a target angular velocity corresponding to a last second future moment and the target duration; and
determining a sum of the first rotation angle and the second rotation angle as the target rotation angle.

19. A terminal device, comprising a processor and a memory,
wherein the memory is configured to store computer-executable instructions; and
the processor is configured to execute the computer-executable instructions stored in the memory to implement a pose prediction method, and the pose prediction method comprises:
acquiring first motion information of a user during a first historical period and a current pose of the user;
determining high-order information associated with motion of the user during the first historical period according to the first motion information;
determining second motion information of the user during a future period according to the high-order information and the first motion information; and
predicting a target pose of the user at a target moment according to the second motion information of the user during the future period and the current pose.

20. A non-transitory computer-readable storage medium, storing computer-executable instructions, wherein a processor, when executing the computer-executable instructions, implements a pose prediction method, and the pose prediction method comprises:
acquiring first motion information of a user during a first historical period and a current pose of the user;
determining high-order information associated with motion of the user during the first historical period according to the first motion information;
determining second motion information of the user during a future period according to the high-order information and the first motion information; and
predicting a target pose of the user at a target moment according to the second motion information of the user during the future period and the current pose.
